(19) United States
(12) Patent Application Publication
(10) Pub. No.: US 2024/0424756 A1
(43) Pub. Date: Dec. 26, 2024

(54) A METHOD FOR MANUFACTURING A WIND BLADE AND A WIND BLADE MANUFACTURED WITH SAID METHOD

(71) Applicant: BLADEWORKS S.R.L., Napoli (IT)

(72) Inventor: Angelo D'ETTORE, Castel Volturno (IT)

(73) Assignee: BLADEWORKS S.R.L., Napoli (IT)

(21) Appl. No.: 18/570,708

(22) PCT Filed: Jul. 6, 2022
(86) PCT No.: PCT/IB2022/056231

§ 371 Date: Dec. 15, 2023

(30) Foreign Application Priority Data
Jul. 6, 2021 (IT) 102021000017771

(51) Int. Cl. B29D 99/00; B29C 70/44; B29C 70/54; B29L 31/08

(52) U.S. Cl. CPC B29D 99/0028; B29C 70/443; B29C 70/546; B29L 2031/085

(57) ABSTRACT

A wind turbine that has a blade extending along an axis is made of a composite material made of filaments. A method for manufacturing the blade includes: laying on a first mould a plurality of sheets of fibre of a material, laying second moulds above the plurality of sheets of the fibre material, laying on the second moulds sheets of a fibre material, laying a third mould on the first mould to create at least one closed volume between the first mould and the third mould inside of which the plurality of sheets of fibre laid down and the second moulds are housed, injecting fluid material having resin to impregnate the plurality of sheets, removing the first and third moulds from the outside of a blade that is formed, and removing the second moulds from the inside of the blade through a cavity of the blade.

### CROSS-REFERENCE TO RELATED APPLICATIONS

This application is a national stage application filed under 35 U.S.C. § 371 of PCT Application No. PCT/IB2022/056231, filed Jul. 6, 2022, which claims priority to Italian Patent Application No. 102021000017771 filed on Jul. 6, 2021, the entire disclosure of each of which is incorporated herein by reference.

### BACKGROUND OF THE DISCLOSURE

### 1. Field of the Disclosure

This disclosure relates to a method for manufacturing a wind blade and a wind blade manufactured with said method.

### 2. Description of Related Art

A blade of a wind turbine generally comprises a root for connecting the blade to the hub; a support frame connected to the root; and a casing that defines the wing profile of the blade and is supported by the support frame.

The blades of wind turbines reach great lengths and are placed under a lot of stress by the wind during operation. The stresses are transmitted from the casing to the support frame, which is configured to resist the stresses.

The support frame, as shown in the documents US 2009/0136355 A1 and US 2010/0068065 A1, basically comprise a tubular spar that, in cross section, has a rectangular shape. In more detail, the tubular spar comprises two parallel slabs facing each other and designed to be connected to the casing; and two parallel webs facing each other. In use, the slabs are directly in contact with the casing or, in some cases, themselves form part of the casing and of the blade profile and are subject to stresses of bending moment, while the webs are mainly subject to shear stresses.

In particular, the known production techniques, for example, from the documents WO 2009/153341, WO 2009/153342, and WO 2009/153343 involve moulding the two slabs and the two webs, and connecting the slabs and webs together, mainly by gluing, to create the tubular spar.

An alternative production method involves moulding two U-shaped elements and joining, by gluing, the two U-shaped elements as shown in the document US 2005/0214122.

As can be seen in the prior art, a blade is manufactured using numerous steps and with numerous components, some of which are glued together, for example the slabs of the spar are glued to the casing. This entails complex processes, long production times, and a danger of breaking some internal components or the imperfect hold of the steps for gluing the various components together.

### SUMMARY

One purpose of this disclosure is to provide a method to manufacture a blade of a wind turbine that reduces the drawbacks of the prior art.

Another purpose of this disclosure is to provide a method for manufacturing a blade of a wind turbine that obtains a blade with a simple and less costly process, but, at the same time, one that is resistant to loads.

According to this disclosure, a method is provided for manufacturing a blade of a wind turbine according to one of the attached claims.

Thanks to this disclosure, the blade manufacturing process reduces the times and costs for manufacturing said blade, together with the reduction of the structural weight of the blade and/or greater resistance to the stresses of said blade.

In addition, in comparison to the prior art, it reduces the waste produced during the blade manufacturing process.

### BRIEF DESCRIPTION OF THE DRAWINGS

Additional features and advantages of this disclosure will be clear from the description that follows of its non-limiting embodiments, with reference to the attached figures, in which:

FIG. 1 is a side view of a blade manufactured according to this disclosure;

FIG. 2 is a cross-section view, with parts removed for clarity, of the blade in FIG. 1;

FIG. 3 is a simplified diagram of one step of the method for manufacturing the blade in FIG. 1;

FIG. 4 is a simplified diagram of another step of the method for manufacturing the blade in FIG. 1;

FIG. 5 is a simplified diagram of another step of the method for manufacturing the blade in FIG. 1; and

FIG. 6 is a schematic view, from above, of a mould for manufacturing the blade in FIG. 1.

### DETAILED DESCRIPTION OF THE DISCLOSURE

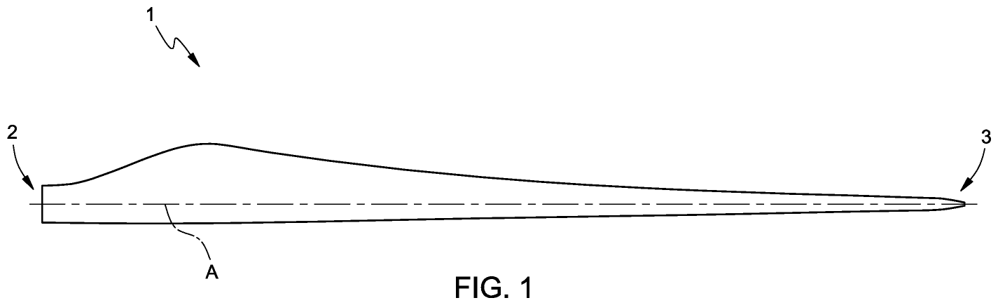

With reference to FIG. 1, the reference number 1 indicates, as a whole, a blade of a wind turbine.

The blade 1 extends along a given axis A and is made of composite material comprising filaments arranged in at least two directions.

In addition, the blade 1 extends from one root 2 to a tip 3 of the blade; in particular, it extends along the axis A.

The root 2 of the blade 1, in use, is connected to a hub of a wind plant (not illustrated), in particular to a hub of a wind turbine (not illustrated).

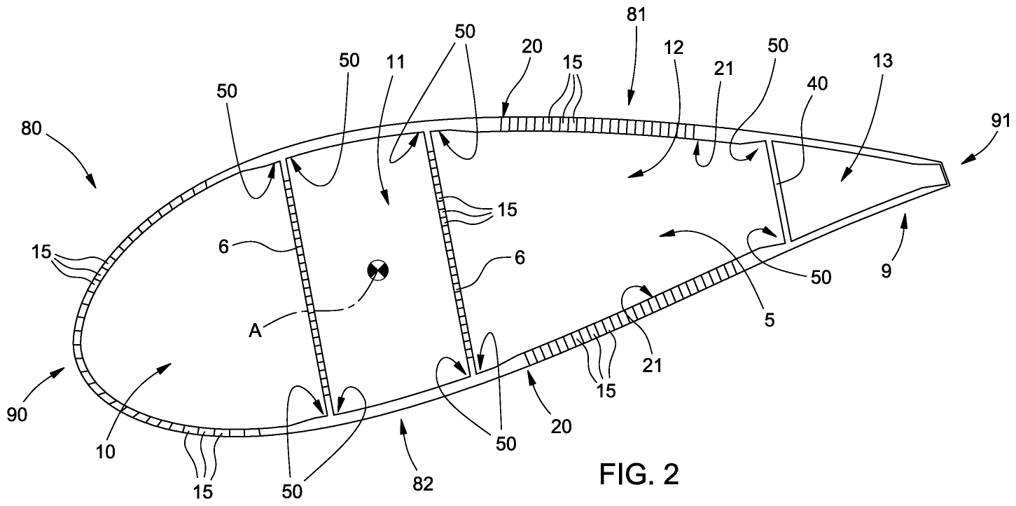

With reference to FIG. 2, the blade 1 consists, internally, of a hollow structure 5 comprising two webs 6.

In an alternative embodiment, there are no webs 6 within the hollow structure 5 and, throughout the discussion of the disclosure, they are to be considered as optional.

In one alternative embodiment, the blade 1 comprises any number of webs greater or equal to one, by way of non-limiting example: one or three or four or five or six or seven or eight.

With reference to FIG. 2, the hollow structure 5 comprises three cavities: one cavity 10 facing the leading edge 90 of the blade 1, one main cavity 11, and one cavity 12 facing the outlet edge 91 of the blade 1, wherein the main cavity 11 is arranged between cavity 10 and cavity 12.

In addition, the blade 1 comprises a back element 13 that is placed in a back area 9, adjacent to the outlet edge 91, of the blade 1 and that comprises, internally, a low-density foam. In particular, the layer of low-density foam comprises polyurethane material having a density that ranges from 10 kg/m³ to 100 kg/m³, in particular 30, 40, 50 kg/m³.

In addition, the structure of the blade 1 has a layer of composite material, in particular comprising fibres and resin, that extends from the outer surface 20 of the blade 1 to the inner surface 21 of the blade 1. In particular, the fibres comprise filaments arranged in at least two, incident directions, in particular directions that are perpendicular to each other.

In more detail, the layer of composite material is single and is made in a single step, in the sense that there are no parts glued together but it is made as a single, integral piece.

In a preferred, but non-limiting, embodiment of this disclosure, in some areas of the blade 1, the structure comprises one or more core elements 15 that are embedded in the composite material between the outer surface 20 and the inner surface 21 and form a single whole with the composite material structure. In other words, said core elements 15 are embedded and integrated within the composite material structure.

In a preferred, but non-limiting, embodiment, the core elements 15 are distributed and embedded, at least for a section, in a front portion 80 of the blade 1, which comprises the leading edge 90 of the blade 1, and which preferably is located at least partially around the cavity 10, and/or in a back portion 81 of the blade 1, which comprises the outlet edge of the blade 91, and, preferably, is situated at least partially around another cavity 12.

Usually, the core elements 15 comprise a PVC or PET or Balsa material or other core materials, in particular having a density that ranges from 40 kg/m³ to 300 Kg/m³, in particular 60 or 80 kg/m³.

In a central portion 82 of the blade 1 that is arranged between the front portion 80 and the back portion 81, in a preferred embodiment of this disclosure, the structure of the blade 1 only consists of the composite material, comprising fibre sheets and resin, preferably without core elements 15. As a result, the structure of the central portion 82 of the blade 1 defines a continuous structure without interruptions in material comprising, preferably exclusively, fibre sheets and resin. In other words, in some areas of the blade 1, in particular some areas in the central portion 82 of the blade 1, the structure of the blade 1 consists of a single layer comprising fibre sheets and resin that goes from the outer surface 20 of the blade 1 to the inner surface 21 thus defining both a portion of the outer surface 20 of the blade 1 and an inner surface 21 of the blade 1, in particular of the cavity 5.

In addition, in the portions of the blade 1, for example in at least parts of the front portion 80 and in at least parts of the back portion 81, wherein there are core elements 15, these core elements 15 are integrated and completely enveloped by the composite material. In particular, they are incorporated inside the composite material and enveloped by the resin and fibres forming, thus, a single and integral structure, in particular without using glue.

In addition, in the embodiment of the blade 1 wherein there are one or more webs 6, the at least one web 6 forms a single structure, in particular integral and integrated together with the central portion 82 of the blade, in particular a single, continuous structure, in particular without interruption or discontinuity of material.

In other words, the one or more webs 6 constitute a single and integrated structure with the portions of the blade 1, in particular with the central portion 82 of the blade 1, and are formed of a single piece, preferably not glued.

In more detail, the at least one web 6 comprises fibre sheets and resin and can comprise core elements 15 embedded in the fibre sheets and resin so as to form a single structure.

The webs 6 are manufactured together with the rest of the structure of the blade 1, in particular together with the central portion 82 of the blade 1. As a result, they constitute a single and integral structure, preferably without using glue and pieces glued together as in the prior art.

In particular, the structure of the blade 1, in particular along portions of the inner surface 21, and the at least one web 6 form angles 50 where there is continuity of material. In more detail, in the angles 50 there is no glue to hold the webs 6 together and the structure of the blade 1, in particular along the inner surface 21.

In addition, the back element 13 is arranged between the back portion 81 of the blade 1, in particular along the inner surface 21, and is integrated into the structure of the blade 1. In particular, the back element 13 is arranged and connected to two inner surfaces 21 of the blade 31 facing each other. The back element 13 is fixed along the inner surfaces 21 of the blade 1 facing each other at the back portion 81 of the blade 1, in particular at the outlet edge 91 of the blade 1.

In addition, the back element 13 is fixed along the inner surfaces 21 of the blade 1 facing each other during the process of infusion using injected resin, as will be illustrated in detail below, so as to become a single and integral piece.

In other words, the element 13 is not glued along the surfaces of the blade 1 but is integrated with them during the process of infusion of the blade 1, in particular during the injection of the material comprising resin. These gives the whole structure greater solidity.

In one preferred, but non-limiting, embodiment of this disclosure, the blade 1 comprises a back wall 40 in contact with the back element 13; in other words, in this embodiment, the back element 13 is arranged in the back portion 81 of the blade 1, in particular along the inner surface 21, and in contact with the back wall 40, and is integrated into the structure of the blade 1. The back wall 40 is fixed to the element 13 and to the structure of the blade 1, in particular along portions of the inner surfaces 21 facing each other, via the resin injected during the infusion process, preferably without using glue.

In more detail, the structure of the blade 1 that defines the outer surfaces 20 is a unitary structure comprising sheets of fibre material and resin and is held together by the resin, which defines an integral structure preferably without parts glued together. This gives the blade 1 greater strength, in general, and makes it lighter. In addition, the manufacturing process is simplified and produces less waste.

In more detail, the fibre sheets, the core elements 15, the back element 13, preferably the back wall 40, preferably the portions 80, 81, and 82 of the blade 1 form a unitary structure held together by the resin, which defines an integral structure, preferably without parts glued together. This gives the blade 1 greater strength, in general, and makes it lighter. In addition, the manufacturing process is simplified and produces less waste. In particular, the inner structure of the blade 1 and the back wall 40, or the back element 13, if there is no back wall 40, form angles 50 where there is continuity of material. In more detail, in the angles 50 there is no glue to hold the back wall 40 together with the inner structure of the blade 1.

In more detail, the at least one web 6 and/or the back wall 40 are not glued, as in the prior art, on the inner surfaces 21 of the blade 1 facing each other, in particular along the angles 50, but are made together with the layer of composite material of the portions of the blade 1 and define a single structure. In other words, the at least one web 6 and/or the back wall 40 and the portions of the blade 1 constitute a unitary structure preferably without discontinuity and/or interruption and/or elements glued together. In other words, the at least one web 6 and/or the back wall 40 and the portions of the blade 1 constitute a continuous unitary structure that does not have interruptions or discontinuities of material, or of another kind, and, as a result, is stronger because it does not have points of discontinuity. This unitary structure between the webs 6 and/or the back wall 40 and the portions of the blade 1 is made possible thanks to a single infusion of resinous material that is carried out based on the manufacturing method illustrated below. In particular, the blade 1 along the angles 50 has a continuous structure, without discontinuity of material.

In the embodiment with at least one web 6, the at least one web 6, the core elements 15, the back element 13, and preferably one or more of the portions 80, 81, and 82 of the blade 1, and preferably the back wall 40, form a unitary structure held together by the resin and that defines an integral structure without parts glued together. This gives the blade greater strength, in general, and makes it lighter. In addition, the manufacturing process is simplified and produces less waste.

The blade 1 is made using a single infusion with a method that will be described below.

In particular, the fibre sheets and, when present, the core elements 15, the back element 13, and the back wall 40, are held together and impregnated with the resin via a single infusion and, as a result, define a single and integral structure of the blade 1, which preferably has load-bearing features. As mentioned above, the single and integral structure of the blade 1 can comprise one or more webs 6. The portions 80, 81, and 82 of the blade 1 described are part of the single and integral structure of the blade 1 and, in fact, constitute, therefore, a single structure. In other words, the term “portions” does not indicate separate and/or disconnected parts, but just different areas of the same single and integral structure.

The blade 1 is manufactured using the production method of the blade 1 that will be illustrated below.

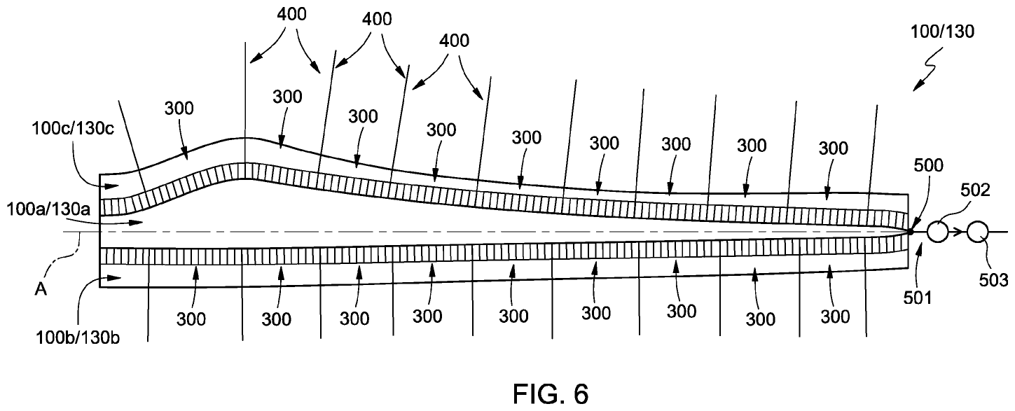

This method involves the use of two outer moulds 100 and 130, one of which is schematically illustrated in FIG. 6.

The two outer moulds 100 and 130 can be re-used to implement the method multiple times.

In particular, the two outer moulds 100 and 130 can be re-sued to produce multiple blades in succession, in particular by implementing the production method of the blade, illustrated below, multiple times.

In particular, the two outer moulds 100 and 130 can be reused multiple times and, in particular, are single-use.

In particular, each of the two outer moulds 100 and 130 comprises a central portion 100a/130a and two side portions 100b/130b and 100c/130c. In addition, at least one of either the first mould 100 or the third mould 130, preferably both the moulds 100 and 130, comprises multiple channels 300 made along at least one of the side portions 100b and 100c (130b and 130c), preferably along both the side portions 100b and 100c (130b and 130c).

In a preferred version of this embodiment, the channels 300 are made along the whole side portion 100b and/or 100c and/or 130b and/or 130c.

In a preferred embodiment, the channels 300 are arranged in a line, preferably like a comb, along at least one of the side portions 100b/100c/130b/130c of the mould 100/130 and spaced apart from each other by a given spacing value. The given spacing value ranges between 20 mm and 500 mm.

In particular, the channels 300 are made along the surface of the side portions 100b/100c/130b/130c along a transverse direction preferably radial in relation to the axis A. The channels 300 arranged along the same side portion 100b/100c/130b/130c of the mould 100/130 are all connected together. In addition, in their turn, they are connected to conduits 400 that connect the channels 300 to the outside of the mould 100/130 and feed the channels 300. In particular, the number of channels 300 and the number of conduits 400 is connected by a ratio k. In particular, the ratio k between the number of channels 300 and the number of conduits 400 ranges between 10 and 100, preferably 20, 30, 40, 50, 60.

In other words, in the moulds 100/130, there is, preferably, a conduit 400 in every 20/30/40/50/60 channel 300. In other words, each conduit 400 feeds a number of channels 300 included in a range from 10 to 100, in particular 20, 30, 40, 50, 60.

In other words, the multiple channels 300 are grouped together in groups of channels 300, each group of channels 300 is directly fed by a conduit 400. Each group of channels 300 comprises a number of channels from 10 to 100, preferably 20, 30, 40, 50, 60. The groups of channels 300 made along the same side portion 100b/100c/130b/130c of the mould 100/130 communicate with each other. As a result, all the channels 300 made along the same side portion of the mould communicate with each other, preferably the channels 300 of the same group of channels 300 are configured to be fed through a preferential route from the corresponding conduit 400 connected to said group of channels 300. In more detail, the connection that places two different groups of channels 300 in communication comprises greater resistance to fluids, preferably a pressure drop, compared to the connection within the groups of channels 300.

In addition, at least one of the moulds 100, 130 comprises an outlet hole 500, an outlet conduit 501, a filter 502, and a pump 503.

In particular, the outlet hole 500 is made at any point of the mould 100, 130 and is connected to a filter 502 via the outlet conduit 501. In addition, downstream of the filter 502, a pump 503 is connected that is configured to suck on the side in which it is connected to the filter 502.

In other words, the outlet hole 500 is connected to the pump 503 via the connection conduit 501 and the filter 502 is positioned 503 along the connection conduit 501 between the outlet hole 500 and the pump. The pump 503 is connected to the outlet hole 500 so as to suck from the outlet hole 500.

In particular, in one non-limiting embodiment of this disclosure, there is just one outlet hole 500. In particular, thanks to the multiple channels 300 that are connected together, just one outlet hole 500 to suck the air is enough for one embodiment.

The filter 502 is configured to enable the passage of fluids in the gaseous state and block the passage of fluids in the liquid state. In this way, just air, or other fluids in the gaseous state, is sucked up and neither the resin nor other fluids in the liquid state is sucked up.

As will be illustrated below, the moulds 100 and 130 are hermetically closed and are in contact along the respective side portions 100b and 130b and 100c and 130c, so as to form a closed volume 200 inside of the moulds 100 and 130. As will be illustrated in detail, the channels 300 and the conduits 400 have the function of enabling the passage from the outside of the moulds 100 and 130 inside of the closed volume 200 of a fluid material, preferably liquid, comprising resin and a hardening catalyst, which impregnates the material sheets 101 to make the composite material of the blade 1.

In particular, a sealing element 140, preferably comprising neoprene and/or butyl rubber, is placed between the first 100 and the third moulds 130 to create said closed volume 200 between the first mould 100 and the third mould 130. In particular, the sealing element is placed between the side portions 100a, 100c of the first mould 100 and the side portions 130a, 130c of the third mould 130. In particular, it is in contact on one side with the side portions 100a, 100c of the first mould 100 and, on the other side, with the side portions 130a, 130c of the third mould 130.

The side portions 100b, 130b, 100c, 130c with the sealing element 140 placed between them define a closure that ensures a hermetic seal in the closed volume 200 between the first and the third mould 100, 130, in particular under high vacuum.

In addition, the method uses one or more inner moulds 102 that, in use, are housed in the closed volume 200.

The inner moulds 102 like the outer moulds 100, 130 can be re-used multiple times. In other words, the inner moulds 102 can be re-used to produce multiple blades in succession, preferably the inner moulds 102 can be re-used to implement the blade manufacturing method illustrated below multiple times. The inner moulds 102 are preferably not single-use.

In one embodiment, along the outer surface 102a of the inner moulds 102, there are multiple additional channels (not illustrated in the attached figures) grouped in groups of additional channels fed by multiple additional conduits, in particular each group of additional channels is directly fed by a corresponding additional conduit. In particular, each group of additional channels comprises a number of additional channels that ranges from 10 to 100, in particular 20/30/40/50/60. In other words, the ratio between the number of additional channels and the number of additional conduits is a value that ranges from 10 to 100, in particular 20/30/40/50/60. All the additional channels made on the same inner mould 102 are preferably connected to each other.

In one preferred embodiment, the additional channels are arranged spaced apart by an additional given spacing value. The additional given spacing value ranges between 20 mm and 700 mm.

The outer moulds 100 and 130 comprise a hermetic passageway (not illustrated in the figures attached) through which the additional conduits of the inner mould 102 pass from the closed volume 200 to the outside of the outer moulds 100 and 130.

As will be illustrated below, the additional channels and conduits serve to inject a fluid material, preferably comprising resin and a fixative inside the closed volume and to impregnate the sheets of fibre material so as to create the composite material of the structure of the blade 1.

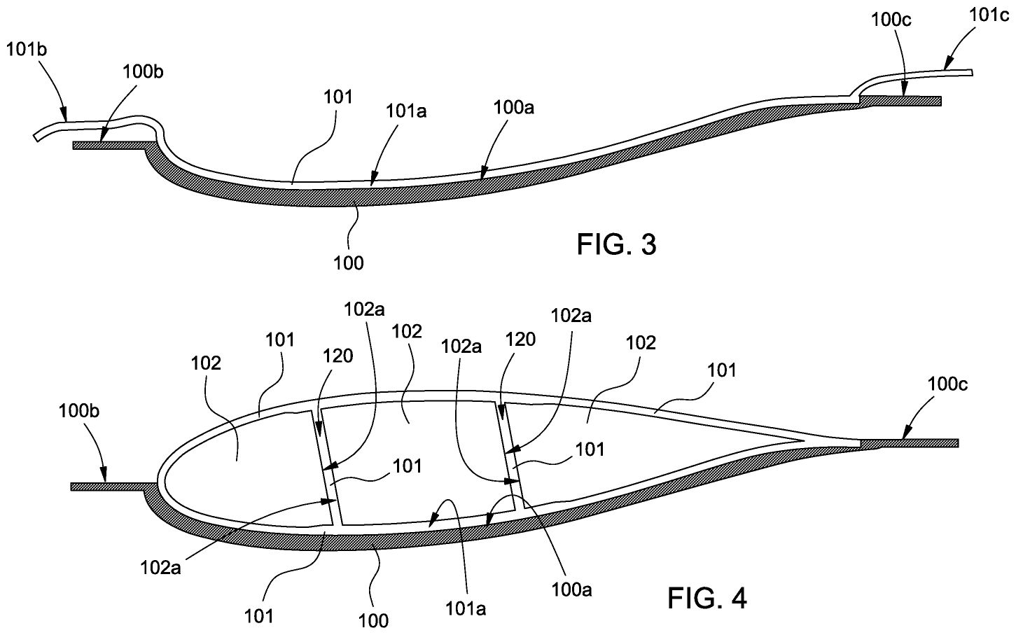

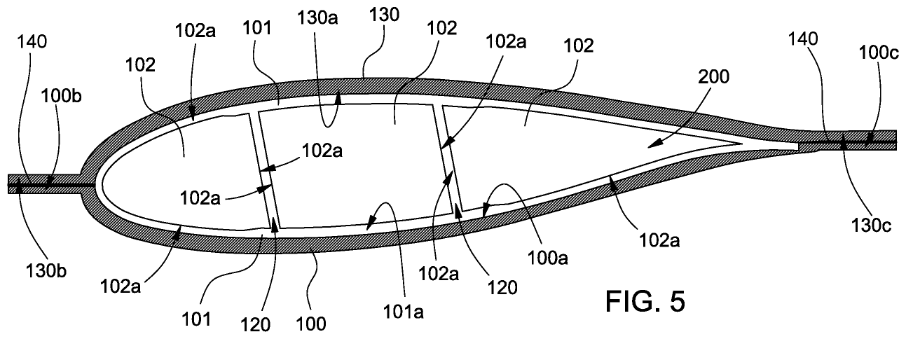

With reference to FIGS. 3, 4, and 5, the production method for the blade 1 comprises the steps of:
a) providing the first mould 100, which preferably defines an outer and lower first mould;
in particular, the first mould comprises the central portion 100a and two side portions 100b and 100c;
b) placing on the first, preferably outer, mould 100, multiple sheets 101 of fibre of a material, preferably glass or carbon; in particular, placing the multiple fibre sheets 101 along the central portion 100a of the mould 100 and along the side portions 100b and 100c so as to have the central portions 101a of fibre sheets placed and side portions 101b and 101c of fibre sheets placed; in particular, the multiple sheets 101 are placed both one on top of the other and one next to the other; in particular, a first layer of sheets of material is placed on the mould 100 in which each sheet of material partially overlaps another and, subsequently, multiple layers of sheets of material are laid down, wherein, preferably during the placement, each sheet overlaps the next sheet for a portion of its sheet, preferably each sheet partially overlaps the adjacent sheets; in particular, the placement of the layers of sheets of material is carried out so that there is no clear discontinuity between the adjacent sheets and between the overlapping sheets; in addition, as said above, a portion of some sheets is preferably placed on the central mould 100a and placed on the side portions 100b or 100c so as to have central portions 101a of fibre sheets placed and side portions 101b and 101c of fibre sheets placed so that these sheets can be wound around successive moulds to form, at least partially, the side portions 80 and 81 of the blade 1;
bbis) in one optional embodiment of this disclosure: placing between the fibre sheets 101 of material during step b) one or more prefabricated elements and/or pultruded elements, preferably made of carbon fibre and/or glass to increase the stiffness of the structure of the blade 1 and/or core materials, and that will be incorporated between the sheets of fibre material; in particular, the prefabricated elements and/or the pultruded elements and/or the core materials are placed along the central portion 101a of the multiple sheets 101; in one preferred, but non-limiting, embodiment of this disclosure, the prefabricated elements and/or the pultruded elements and/or the core materials are exclusively placed along the portion 80 and 81 of the blade 1 and to form the webs 6;
btris) in one optional embodiment of this disclosure: placing between the sheets of fibre material during step b), one or more core elements 15, preferably comprising a PVC or PET or Balsa material, or other core materials, in particular that have a density ranging from 50 kg/m³ to 300 Kg/m³, in particular 60 or 80 or 100 or 120 kg/m³; in particular, the core elements 15 are placed along the side portions 80 and 81 of the blade 1;
c) placing the second stiff moulds 102 (FIG. 4) above the multiple sheets 101 of fibre material previously laid down during step b); in particular, the second moulds 102 are placed above the central portion 101a of the multiple sheets that correspond to the central portion 100a of the mould 100;
cbis) in one optional embodiment of this disclosure: during step c), at least two of the second moulds 102 are positioned so that between said at least two of the second moulds 102 there is a gap 120 and, subsequently, multiple sheets 101 of fibre material are placed between the at least two of the second moulds 102 inside of the gaps 120 to create the at least one web 6; in particular, at least two of the second moulds 120 are positioned so that they are not in contact with each other along respective surfaces 102a facing each other for at least a portion of said surfaces 102a so as to form the at least one gap 120 between said at least two of the second moulds 102 along the at least one portion of said surfaces 102a; in an additional preferred form of this embodiment, one or more core elements 15 are placed in the gap 120, preferably comprising a PVC or PET or Balsa material, or other core materials, in particular that have a density ranging from 50 kg/m³ to 300 Kg/m³, in particular 60 or 80 or 100 or 120 kg/m³;
ctris) in an optional form of this disclosure, as an alternative to that in step cbis), before step c), at least two of the second moulds 102 are wrapped around by multiple sheets 101 of fibre material before being positioned above the mould 100; in this way, the second moulds 102 are positioned spaced apart between them, in particular not in direct contact between them, along respective surfaces 102a facing each other for at least a portion of said surfaces 102 so as to form the at least one gap 120 between said at least two of the second moulds 102 along the at least one portion of said surfaces 102a; in a preferred, but non-limiting, embodiment of this disclosure, the gap 120 is additionally filled with sheets 101 of fibre material to create the at least one web 6; in a preferred, but non-limiting, embodiment of this step ctris), in an additional preferred form of this embodiment and again before step c), one or more core elements 15 are placed in the gap 120, preferably comprising a PVC or PET or Balsa material, or other core materials, in particular that have a density ranging from 50 kg/m³ to 300 Kg/m³, in particular 60 or 80 or 100 or 120 kg/m³; in particular, the placement of the core elements 15 in the gap 120 is carried out before the placement of the sheets of material in the gap 120 or at the same time as this;
cquater) in one optional form of this disclosure: during step c), the back element 13 is also laid down above the plurality of sheets 101 of fibre material previously laid down during step b) and above the mould 100; in this embodiment, the second mould 102 adjacent to the back element 13 is not placed in contact with it and there is an additional gap that is filled with fibre sheets and preferably with core elements to create a back wall 40;
d) folding the side portions 101b and 101c of the multiple fibre sheets 101 previously placed on the side portions 100b and 100c of the mould 100 and placing them above the moulds 102;
dbis) in one optional embodiment of this disclosure: placing additional, multiple sheets 101 of fibre material, preferably glass or carbon, on the second moulds 120 and, preferably, on the side portions 101b and 101c of the multiple sheets laid on the moulds 102 during step d); in more detail, the multiple sheets 101 are placed both one on top of the other and one next to the other; in particular, a layer of sheets of material is placed on the second moulds 120, wherein each sheet of material partially overlaps another and the side portions 101b and 101c laid down on the second moulds 120; multiple layers of sheets of material are subsequently laid down, in which, during their placement, each sheet overlaps the adjacent sheet for a portion of its own sheet; in more detail, the placement of the layers of sheets 101 of material is carried out so that there is no clear discontinuity between the adjacent sheets 101 and between the overlapping sheets 101; in addition, as said above, a portion of some sheets 101 laid on the central mould 120 is placed on the side portions 101b or 101c of fibre sheets wrapped around the second moulds 102 to form, at least partially, the side portions 80 and 81 of the blade 1, so as to have a continuous and strengthened structure;
dtris) in one optional embodiment of this disclosure: placing between the sheets of fibre material during step d) and/or dbis) one or more core elements 15, preferably comprising a PVC or PET or Balsa material, or other core materials, in particular that have a density ranging from 50 kg/m³ to 300 Kg/m³, in particular 60 or 80 or 100 or 120 kg/m³; in particular, the core elements are put along the side portions 80 and 81 of the blade 1;
dquarter) in one optional embodiment of this disclosure: placing between the sheets of fibre material during step d) and/or dbis) and/or dtris), one or more prefabricated elements and/or pultruded elements preferably made of carbon fibre and/or glass to increase the stiffness of the structure of the blade 1 and/or core materials and that will be incorporated between the sheets of fibre material; in particular, the prefabricated elements and/or the pultruded elements and/or the core materials are placed along the central portion 101a of the multiple sheets 101, in one preferred, but non-limiting, embodiment of this disclosure; the prefabricated elements and/or the pultruded elements and/or the core materials are exclusively placed along the portion 80 and 81 of the blade and to form the webs 6;
e) placing a third mould 130, preferably an outer one, on the first mould 100 to create at least one closed volume 200 between the first mould 100 and the third mould 130 inside of which the multiple sheets 100 of material laid down and the second moulds 102, and, in the optional embodiments, the core elements 15 and/or core materials and/or prefabricated elements and/or pultruded elements and/or the back element 13 and or the back wall 40 and or the webs 6, are housed; in particular, the third mould 130 comprises a central portion 130a and two side portions 130b and 130c; in particular, during step e), the third mould 130 overlaps the first mould 100 so that the side portions 100b and 100c of the first mould 100 are in perfect contact with the side portions 130b and 130c of the third mould 130 and the closed volume 200 is created between the central portion 100a of the first mould 100 and the central portion 130a of the third mould 130; in particular, one mould 100 and another mould 130 are hermetically closed between them along the respective portions 100b and 130b and 100c and 130c. In this way, the closed volume 200 is hermetically closed towards the outside of the moulds 100 and 130 and they define a mould assembly that is closed in relation to the outside; as a result, the closed mould assembly encloses inside the moulds 102 and the fibres 101 and, in the optional embodiments, the core elements 15 and/or core materials and/or prefabricated elements and/or pultruded elements and/or the back element 13 and/or the back wall 40 and/or the webs 6;
f) in an optional embodiment: rotating the closed mould assembly so as to position the front edge of the blade 1 downwards; in particular, the mould assembly is rotated so that the portions 100b and 130b are turned downwards and the portions 100c and 130c face upwards;
g) in an optional embodiment: applying the vacuum to the closed mould assembly; in particular, through the channels of the first mould 100 and/or the third mould 130, preferably the vacuum is created without needing to use a vacuum seal bag;
h) injecting a fluid material, preferably liquid, comprising resin and a hardening catalyst, inside the mould assembly, in particular between the first mould 100 and the third mould 130, preferably through the channels 300 and the conduits 400 of at least one of the moulds 100 and 130, preferably both, and in one optional embodiment through the additional channels and the additional conduits of at least one of the inner moulds 102, preferably all the inner moulds, to impregnate the plurality of sheets 101 of fibre material, preferably glass or carbon, placed between the first 100 and the third mould 130; in a preferred embodiment that comprises step f), the fluid material is injected from the lower part of the mould assembly, in particular at the portions 130b and 100b, in particular in one embodiment the fluid material is epoxy resin;
i) waiting for the fluid material to harden so as to create a single structure of composite material comprising the fluid material comprising the resin and the plurality of sheets of fibre material and in the preferred, optional embodiments, the core elements 15 and/or the core materials and/or the prefabricated elements and/or the pultruded elements and/or the back element 13 and/or the back wall 40 and/or the webs 6; in this way, the blade is formed;
ibis) in one optional embodiment of this disclosure, one acts, thermally, on the temperature of the fluid material comprising resin previously injected into the mould assembly, for example by heating the mould assembly and/or the inner moulds 102 or cooling the mould assembly and/or the inner moulds 102;
l) removing the moulds 100 and 130;
m) removing the moulds 102 from inside the blade 1, in particular from the root of the blade 1; in more detail, the moulds 102 are removed from the cavity of the blade 1 through the root 2 of the blade that has an opening having a given diameter and/or a given minimum dimension; in more detail, each mould 102 comprises a maximum dimension that is transverse, in particular perpendicular, to the length of each mould that is less than the diameter and/or the minimum dimension of the opening made in the root 2 of the blade 1; in particular, the opening through the root 2 places the inside of the blade 1 in communication with the outside of the blade 1; in a preferred embodiment, there is more than one mould 102; in other words, the blade 1 comprises a cavity and an opening in the root 2 of the blade 1 having a given diameter or a minimum dimension that is transverse, in particular perpendicular, to the axis A; the diameter or the minimum dimension of the opening of the root 2 is greater than the maximum dimension of the diameter, and/or the dimension perpendicular and/or transverse to the length, and/or of the maximum dimension of a maximum section of each of the inner moulds 103; in this step, then, the extraction of the inner moulds through the cavity 2 of the blade 1 occurs after the blade 1 has been formed;
n) in an optional form of this disclosure: drilling holes radial to the axis A and holes parallel to the axis A along the circumferential surface of the root 2 of the blade 1 located at the opening of the cavity of the blade 1; these radial holes are configured to accommodate a fastener between the root of the blade 1 and a hub of a wind turbine.

In an optional form of this disclosure, the production method comprises the step of heating at least one of the moulds 100, 102, and/or 130, in particular heating one or more of the outer moulds 100 and/or 130.

In particular, the blade 1 being made of a single piece inside the closed volume 200 between the first mould 100 and the third mould 130.

In particular, the second moulds 102 are stiff, in particular so that the volume and/or the shape, preferably outer, of said second moulds 102 does not vary when subject to an applied pressure, in particular on the outer surface 102 of said second mould 102.

In a preferred, but non-limiting, embodiment of this disclosure, the second moulds 102 are stiff so that when a pressure is applied to the outer surface of the second mould 102 the transverse sections of the second mould 102 have a maximum movement, in particular in the direction in which the pressure acts, preferably less than 5 mm, in particular less than 2 mm, preferably less than 1 mm, in particular less than 0.5 mm. Preferably, said applied pressure is less than 2 bar, preferably ranging between 1 to 2 bar, in particular from 1.01 to 2 bar, in particular equal to 1.5 bar, 1.8 bar, or 1.9 bar.

In particular, the second moulds 102 are not elastically deformable and/or preferably cannot be inflated.

Thanks to the second stiff moulds 102, the invariability of its volume and/or of its shape is ensured, in particular when subject to the pressure exerted by the first and third moulds 100 and 130.

The technical effect is that you can design the thicknesses of the blade 1 and the inner part of the blade 1 more precisely because there will be no variabilities due to a deformable mould. In other words, the blade 1 will be produced exactly as designed and the process can be repeated. For example, thanks to the stiff second moulds 102, the inner angles 50 of the blade 1 can be made sharp and not rounded and the variability between the various blades 1 produced is less than the prior art, in particular compared to the other processes in which the blade is made of a single piece. Thus, the production process and/or final result can be controlled better than in the prior art, and repeated, and the blade 1 produced is closer to the design compared to the prior art.

In particular, thanks to the process described, with the use of the stiff second moulds 102, it is possible to design and produce the inner spaces of the blade 1 and/or the exact shape of the inner angles 50, because the stiff second moulds 102 make it possible to control the inner spaces in the production process, and repeatability. This influences the seal and resistance to forces of the blade 1 produced; in particular, thanks to this process, the inner angles 50 can be designed and produced both rounded and sharp, depending on the design specifications.

In particular, the blade manufacturing step comprises the step of placing the sealing element 140, preferably comprising neoprene and/or butyl rubber, between the first 100 and the third moulds 130 to create said closed volume 200 between the first mould 100 and the third mould 130; in particular, the sealing element is placed so that it is arranged between the side portions 100a, 100c of the first mould 100 and the side portions 130a, 130c of the third mould 130; in particular, it is in contact, on one side, with the side portions 100a, 100c of the first mould 100 and, on the other side, with the side portions 130a, 130c of the third mould 130.

In one optional embodiment of this disclosure, at least one of the moulds 100, 102, and/or 130, in particular at least one of the moulds 100 and/or 130 comprises multiple channels made along the inner surface of the mould 100 and/or 130—in other words, along the surface that is in contact with the fibre sheets. In this way, the fluid material that is injected from the outside towards the inside of the at least one mould 100 and/or 130 is distributed uniformly inside the closed volume 200.

Wherein the fluid material injected in step h) comprises resin, for example, but not limited to, epoxy resin and/or polyester and/or vinyl ester and/or thermoplastic.

During step h), in one preferred, but non-limiting, embodiment of this disclosure, the fluid material is injected at room temperature.

During step h), in one preferred, but non-limiting, embodiment of this disclosure, the injected fluid material is heated or cooled before being injected.

In one optional embodiment, the method comprises the step of heating to between 10 and 100 degrees Celsius at least one of the following: mould 100, mould 102, mould 130, preferably one of the following: mould 100 or mould 130, preferably before step h), the infusion step for fluid material, or after step h), during step i), to fix the material comprising resin.

In particular, in which at least one of the following: mould 100, mould 102, and mould 130, preferably either mould 100 or mould 130, comprises a heating system for said mould, preferably comprising heating elements embedded in the mould body and configured to heat the mould to a desired temperature; in particular, the heating elements embedded in the body are selected from either: ducts configured to be traversed by a fluid having a temperature between 10 and 100 degrees; and electrical conductors configured to be traversed by an electric current and heat up by the Joule effect.

In one preferred embodiment of this disclosure, the steps of the method from a) to n) are carried out in alphabetical order and in the order in which they were illustrated, except for the optional steps that can not be carried out. When the optional steps are carried out, they are carried out in alphabetical order.

The blade 1 is thus produced via a single infusion of fluid material comprising resin. In other words, the blade 1 is produced with a single infusion; in particular, the blade 1 is held together exclusively via the fluid comprising resin and exclusively thanks to the single infusion that was carried out.

In particular, the blade 1 and its production does not involve any gluing step for parts of the blade subsequent to the infusion of the fluid material comprising resin.

In particular, it does not involve any step of gluing parts of the blade 1 subsequent to the single and only infusion step of fluid material comprising resin. In addition, in a preferred embodiment, the blade and its production does not involve any step of gluing parts of the blade, nor preceding the infusion of the resin nor after the infusion of the resin; in particular, the process involves a single infusion of the resin.

In other words, the fluid infusion step, which is only one, determines the adhesion of the parts of the blade 1 between them, in particular of all the parts of the blade 1, in particular the plurality of fibre sheets 101 and, in the optional embodiments, the core elements 15, the core materials and/or the prefabricated elements and/or the pultruded elements and/or the back element 13 and/or the back wall 40 and/or the web 6; preferably, the adhesion of all the parts of the blade 1 occurs exclusively during said infusion step for the fluid, comprising resin, that determines the adhesion of the various parts.

The whole process is carried out in a mould assembly that is completely closed, stiff, and can be re-used to create multiple blades. In this way, a vacuum seal bag is not needed, as in the prior art, and there are fewer waste materials during the process and a smaller production of waste and of single-use elements.

In one preferred, but non-limiting, embodiment, the mould assembly is made of composite material comprising resin and sheets of fibre material, for example glass and/or carbon; in particular, in one embodiment, the mould assembly is made of fibreglass.

In particular, the fibre sheets comprise glass and/or carbon fibres.

These fibre sheets are wrapped for 360° around the profile of the blade so as to ensure a higher resistance to forces, with an equal weight compared to the prior art, or an equal resistance to forces, with a lesser weight compared to the prior art. In other words, in a preferred embodiment, the fibre sheets are arranged in various layers, one above the over and one next to the other, paying attention to overlap one portion, and have a portion of fibre sheets in those placed next to each other. In this way, there is never clear discontinuity between the end of a fibre sheet and another and there is continuity in the arrangement of the fibre sheets and a greater resistance of the structure itself.

Thanks to this method, there are no limitations to the number of webs that can be inserted and incorporated inside the blade 1 that are incorporated into the composite material comprising fibre sheets and not glued above or below as in the prior art.

In other words, the webs are incorporated inside the composite material between the fibre sheets and the resin and become an integral part of the structure and, as a result, are always covered by at least one layer of fibre sheets and by the fluid material comprising resin on all sides of the webs.

In the same way, the core elements 15 and/or the core materials and/or the prefabricated elements and/or the pultruded elements and/or the back element 13 and/or the back wall 40 and/or the webs 6 are integrated inside the blade 1 and are always integral to the blade 1 itself and are incorporated into the structure of composite material comprising the fibre material sheets and the resin and are not glued along a surface of the blade as in the prior art but are integral with the blade itself and define a single body with the blade itself.

As a result, the core elements 15 and/or the core materials and/or the prefabricated elements and/or the pultruded elements and/or the back element 13 and/or the back wall 40 and/or the webs 6 are always covered on all sides by at least one layer of composite material of glass fibre or carbon and resin.

In addition, the blade produced thus in a cross-section view has one or more closed sections made of a single continuous fibre material; in particular, this fibre is not discontinuous nor is it cut.

In a preferred step of this disclosure, at least one or more of the following features including: the dimension of the sheets, the sequence of stacking the fibre sheets on at least one of the moulds 100, 102, 130, the shape and size of each mould 100, 102, 130 and/or the shape and size of the core elements 15 and/or the core materials and/or the prefabricated elements and/or the pultruded elements and/or the back element 13 and/or the back wall 40 and/or the webs 6 to be produced is defined using an electronic calculator.

In addition, the whole blade manufacturing process is first simulated and checked by an electronic calculator.

Thanks to this disclosure, the webs are integrated into the structure of composite material, in particular, they are integrated inside of an inner portion and an outer portion of the composite structure of glass fibre and/or carbon.

It is, finally, clear that modifications can be made to the method described, and variants produced thereof, without departing from the scope of the attached claims.

1-19. (canceled)

20. A method for producing a wind blade of a wind turbine, wherein the wind blade extends along a given axis from a root to a tip of the wind blade, wherein the wind blade comprises a composite material comprising filaments arranged in at least two directions, the method comprising the steps of:
laying a plurality of sheets of fibre of a material on a first mould;
laying second moulds on a portion of the plurality of sheets of fibre previously laid, wherein the second moulds are stiff;
laying sheets of fibre material on the second moulds and/or on side portions of the sheets of fibre laid on the first mould to exceed dimensions of the first mould;
laying a third mould on the first mould to create at least one closed volume between the first mould and the third mould within which the plurality of sheets of fibre and the second moulds are housed,
wherein the at least one closed volume comprises channels connecting an outside of the at least one closed volume with the at least one closed volume such that a fluid material comprising resin can be injected into the at least one closed volume;
injecting the fluid material to impregnate the plurality of sheets of fibre housed within the at least one closed volume to form the wind blade; and
removing the first and third moulds from an outside of the wind blade and removing the second moulds from an inside of the wind blade through a cavity of the wind blade.

21. The method of claim 20, wherein the injecting the fluid material step determines adhesion of parts of the wind blade to each other.

22. The method of claim 20, wherein the injecting the fluid material step is a single step for each wind blade produced.

23. The method of claim 20, further comprising the step of heating at least one of the first, second, and third moulds.

24. The method of claim 20, wherein the fluid material is injected at room temperature and/or the fluid material is preheated prior to the injecting.

25. The method of claim 20, wherein at least one of the first, second, and third mould comprises a heating system.

26. The method of claim 20, further comprising the step of laying, between the plurality of sheets of fibre, one or more of: a core element, a core material, a prefabricated element, a pultruded element; a back element; and/or a back wall.

27. The method of claim 20, wherein the at least one closed volume is in communication with an exterior via conduits and channels through which the fluid material is injected to impregnate fibres of the sheets of fibre, wherein at least one of the first mould and the third mould comprises the channels, wherein the channels are made along at least one of the side portions, wherein the channels are in communication with and fed by the conduits, the method further comprising the step of:
impregnating the fibres of the sheets of fibre with the fluid material through the conduits and the channels.

28. The method of claim 20, further comprising the step of laying each sheet of the plurality of sheets of fibre on at least one of the first, second, and third moulds according to a stacking sequence, wherein a computer processor is configured to define the stacking sequence and/or a shape and size of each mould and/or a shape and a size of one or more of the following: a core element, a core material, a prefabricated element, a pultruded element, a back element, and/or a back wall for each wind blade to be produced.

29. The method of claim 20, wherein the root comprises an opening of the cavity, wherein the opening of the cavity has a diameter and/or a minimum dimension, wherein each second mould comprises a maximum transverse dimension to a length of each second mould that is smaller than the diameter and/or the minimum dimension of the opening of the cavity, the method comprising further comprising the step of:
extracting the second moulds through the cavity of the wind blade after the wind blade has been formed.

30. The method of claim 20, further comprising the step of drilling holes radial to the given axis and drilling holes parallel to the given axis along a surface of the root of the wind blade located at an opening of the cavity of the wind blade.

31. The method of claim 20, further comprising the step of laying a sealing element between the first and the third moulds to create the at least one closed volume, wherein the sealing element defines a closure that ensures a hermetic seal of the at least one closed volume.

32. The method of claim 20, further comprising the step of creating a vacuum in the at least one closed volume without using a vacuum seal bag.

33. The method of claim 20, wherein the second moulds are stiff so that a volume and/or a shape of the second moulds does not vary when subjected to a pressure applied on an outer surface of the second moulds.

34. A wind blade for a wind turbine manufactured by the method of claim 20.

35. A wind blade for a wind turbine, comprising:
a tip;
a root;
an axis extending from the root to the tip; and
a single structure made of a composite material, the composite material comprising a plurality of fibres of material and a hardened fluid material comprising resin, the hardened fluid material having been infused into the plurality of fibres of material in a single infusion step so that the single structure is formed as a single integral body.

36. The wind blade of claim 35 further comprising:
at least one element selected from the group consisting of: a core element; a core material; a prefabricated element; a pultruded element; a rear element; a back wall; and a web,
wherein the at least one element is embedded in the composite material.
